(19) United States
(12) Patent Application Publication
(10) Pub. No.: US 2016/0241482 A1
(43) Pub. Date: Aug. 18, 2016

(54) PACKET COMMUNICATION APPARATUS AND PACKET COMMUNICATION METHOD

(71) Applicant: FUJITSU LIMITED, Kawasaki-shi (JP)

(72) Inventor: Tetsumei TSURUOKA, Ichikawa (JP)

(21) Appl. No.: 15/041,890

(22) Filed: Feb. 11, 2016

(30) Foreign Application Priority Data
Feb. 13, 2015 (JP) 2015-026580

(51) Int. Cl. H04L 12/863; H04L 12/721; H04L 29/06

(52) U.S. Cl. CPC H04L 47/621; H04L 69/16; H04L 45/38

(57) ABSTRACT

A packet communication apparatus including: a plurality of processors including a specified processor, a first processor of the plurality of processors being configured to process each acknowledgement packet in a first receive flow that corresponds to a first transmission flow including each data packet corresponding to each acknowledge packet in the first receive flow when the first receive flow has been associated with the first processor, the specified processor being configured to associate a receive flow with a processor when the receive flow has not been associated with the processor and when an amount of data in a transmission flow corresponding to the receive flow is more than a predetermined value.

### CROSS-REFERENCE TO RELATED APPLICATION

This application is based upon and claims the benefit of priority of the prior Japanese Patent Application No. 2015-026580, filed on Feb. 13, 2015, the entire contents of which are incorporated herein by reference.

### FIELD

The embodiments discussed herein are related to packet communication.

### BACKGROUND

Recently, a computer system is often equipped with a multi-core central processing unit (CPU). To adapt to high interface speed, a network interface card (NIC) used for a network connection may have a plurality of queues. When an NIC has a plurality of queues, a CPU intended to process packets in a queue is determined for each queue and a plurality of CPUs concurrently process packets stored in a plurality of queues.

In a communication apparatus having a plurality of receive queues, if packets that the communication apparatus has received are distributed to individual queues at random, there would occur packets reordering depending on amount of the packets staying in a receive queue or a load on a processor. If a packet is reordered in communication according to the transport control protocol (TCP), the reordered packet may be misidentified as having caused a packet loss, in which case unnecessary retransmission processing or processing, such as fast recovery, that temporarily lowers a transmission throughput may be performed. Furthermore, the reordered packet may deteriorate quality in an application that performs real-time communication of voice, moving pictures, and the like.

In view of this situation, a method of distributing received packets to a plurality of queues in consideration of sessions to which packets belong has been also devised. In receive side scaling (RSS), for example, a queue to which to distribute packets is determined according to a hash value calculated from information in a packet header which represent the session to which the packet belongs or about a particular field concerning a flow. As a related technology, a method is also proposed in which a flow key is created from the transmission source identifier and destination identifier of a packet and a processor corresponding to a calculated value obtained by processing the created flow key is determined as a processor intended to process the packet (see Japanese National Publication of International Patent Application No. 2002-538724, for example). In Intel Flow Director, a hash value calculated from a packet header is used to assign a CPU so that a CPU that has performed transmission processing for a flow is the same as a CPU intended to perform reception processing for a response to the flow (Wenji Wu, Phil DeMar, Matt Crawford, “Why Does Flow Director Cause Packet Reordering?”, [online], [searched on Dec. 17, 2014], Internet <URL:
http://arxiv.org/ftp/arxiv/papers/1106/1106.0443.pdf>).

### SUMMARY

According to an aspect of the invention, a packet communication apparatus includes a memory, and a plurality of processors including a specified processor, a first processor of the plurality of processors being configured to process each acknowledgement packet in a first receive flow that corresponds to a first transmission flow including each data packet corresponding to each acknowledge packet in the first receive flow when the first receive flow has been associated with the first processor, the specified processor being configured to associate a receive flow with a processor when the receive flow has not been associated with the processor and when an amount of data in a transmission flow corresponding to the receive flow is more than a predetermined value, a second processor of the plurality of processors being configured to process each acknowledgement packet in a second receive flow that corresponds to a second transmission flow including each data packet corresponding to each acknowledge packet in the second receive flow when the second receive flow has not been associated with the second processor and when an amount of data in the second transmission flow corresponding to the second receive flow is not more than the predetermined value, the specified processor being configured to select the second processor based on each acknowledge packet in the second receive flow.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flowchart that illustrates an example of a communication method according to an embodiment;

FIG. 2 illustrates an example of the structure of a communication apparatus;

FIG. 3 illustrates an example of the hardware structure of the communication apparatus;

FIG. 4 illustrates an example of a transmission flow table according to a first embodiment;

FIG. 5 illustrates an example of another transmission flow table according to the first embodiment;

FIG. 6 is a flowchart that illustrates an example of processing, according to the first embodiment, performed by the communication apparatus to transmit packets;

FIG. 7 illustrates an example of a queue table according to the first embodiment;

FIG. 8 illustrates an example of a distribution table according to the first embodiment;

FIG. 9 is a flowchart that illustrates an example of processing, according to the first embodiment, performed by the communication apparatus to receive packets;

FIG. 10 illustrates an example of a hash value table according to the first embodiment;

FIG. 11 illustrates an example of information, according to a second embodiment, that is used to identify a processor that has performed transmission processing for a flow;

FIG. 12 illustrates an example of a distribution table according to the second embodiment;

FIG. 13 illustrates an example of a transmission flow table according to a third embodiment;

FIG. 14 illustrates an example of another transmission flow table according to the third embodiment;

FIG. 15 illustrates an example of another transmission flow table according to the third embodiment;

FIG. 16 is a flowchart that illustrates an example of processing, according to the third embodiment, performed by the communication apparatus;

FIG. 17 is a flowchart that illustrates an example of processing, according to a fourth embodiment, performed by the communication apparatus;

FIG. 18 illustrates an example of the structure of a communication apparatus, according to a fifth embodiment, that operates a virtual machine;

FIG. 19 illustrates an example of a transmission flow table according to the fifth embodiment;

FIG. 20 illustrates an example of a VM address table according to the fifth embodiment; and

FIG. 21 illustrates an example of a processor table.

### DESCRIPTION OF EMBODIMENTS

When a processor intended to process a flow is determined according to a hash value determined for each flow, distribution rules can be reduced. If, however, processing for a reception flow is assigned independent of the usage state of processors, an imbalance may occur in the usage state of the processors and processing efficiency may thereby be lowered. To improve processing efficiency, it is preferable to determine, for each flow, a processor intended to perform processing. However, the number of flows processed in a communication apparatus has been increased together with an increase in the amount of communication. If a distribution rule is determined for each flow, the number of distribution rules stored in the communication apparatus becomes enormous. The larger the number of distribution rules is, the larger a memory capacity used to store them becomes, making it impossible for the distribution rules to fit within a table size allowed by hardware. Even if an adequate number of rules can be registered, management of entry registration and the like become complex.

An object of the present disclosure is to efficiently process received packets in simple processing.

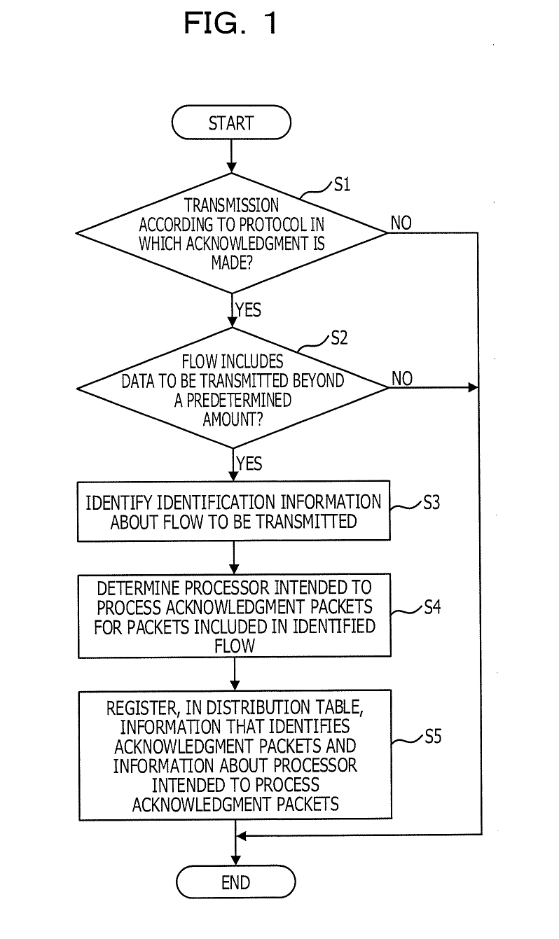

FIG. 1 is a flowchart that illustrates an example of a communication method according to an embodiment, indicating processing performed in a communication apparatus when packets are transmitted; the communication apparatus distributes received packets to receive queues according to distribution rules recorded in a distribution table. The communication apparatus includes a plurality of receive queues and a plurality of processors.

In step S1, the communication apparatus decides whether flows under processing include a flow in which transmission is being performed according to a protocol, such as TCP, in which an acknowledgment is made. In communication according to a protocol, such as TCP, in which an acknowledgment is made, a communication apparatus at the data transmission source receives acknowledgment packets from a communication apparatus at the data destination. That is, the communication apparatus at the data transmission source decides, in processing in step S1, whether the communication apparatus at the data transmission source is highly likely to receive acknowledgment packets from the communication apparatus to which a flow is being transmitted. For a packet in a protocol in which no acknowledgment is made, the communication apparatus at the data transmission source does not perform processing in which a distribution table is used (the result in step S1 is No).

If processing of packets in a protocol in which an acknowledgment is made is being performed (the result in step S1 is Yes), the communication apparatus at the data transmission source decides whether the flow to which the packet belongs includes transmission data beyond a predetermined amount (step S2). As in a case in which a server transmits data to an apparatus that operates as a client, there are many cases in which, while two apparatuses are in communication with each other, one of them transmits a large amount of data and the other only receives data without transmitting data. In a flow in a direction opposite to the direction of a flow through which a large amount of data is transmitted, a large amount of acknowledgment packets without data are highly likely to be transmitted, so it is decided in step S2 whether the flow includes a large amount of transmission data. If the amount of transmission data in the flow does not exceed the predetermined amount, the communication apparatus at the data transmission source does not perform processing for registration in the distribution table (the result in step S2 is No).

If the amount of transmission data in the flow exceeds the predetermined amount (the result in step S2 Yes), the communication apparatus at the data transmission source identifies identification information about the flow to be transmitted (step S3). The communication apparatus determines a processor intended to process acknowledgment packets for the packets included in the identified flow (step S4). Furthermore, the communication apparatus registers, in the distribution table, information that identifies the acknowledgment packets and information about the processor intended to process the acknowledgment packets (step S5).

When processing illustrated in FIG. 1 is performed, the communication apparatus at the data transmission source can select flows due to which a large amount of acknowledgment packets are highly likely to be received and can then determine processors intended to process the selected flows. Therefore, for a flow that involves a processing load equal to or larger than a predetermined value in the communication apparatus, a processor intended to perform processing on received packets can be determined by using a distribution rule so that the efficiency of reception processing is improved.

When a processing load caused by a flow in the communication apparatus at the data transmission source is equal to or larger than a predetermined value, a distribution rule is determined for the flow. However, no distribution rule is determined for a flow that is predicted to involve a relative small processing load. Therefore, the number of distribution rules stored in the communication apparatus is reduced, so the amount of memory used to store distribution rules is reduced and a processing load involved in the registration and management of distribution rules is also reduced.

The communication apparatus that performs processing in FIG. 1 handles, as a target for which to determine a distribution rule, a flow in a direction opposite to the direction of a flow through which a relatively large amount of data is being transmitted. As described above, for a flow in a direction opposite to the direction of a flow through which a relatively large amount of data is being transmitted, it is predicted that the possibility of data being transmitted is relatively low. That is, the communication apparatus determines a distribution rule for a flow for which the probability that acknowledgment packets without data are transmitted is high. Even if an acknowledgment packet without data is reordered, this is nothing more than a sequence number, which indicates successful reception, being reordered and does not involves retransmission processing or the like. Therefore, in a case as well in which processing in which a distribution rule is used is started and a processor intended to perform processing is thereby changed, this does not involve unnecessary retransmission processing or processing that temporarily lowers a transmission throughput.

Structure of the Apparatus

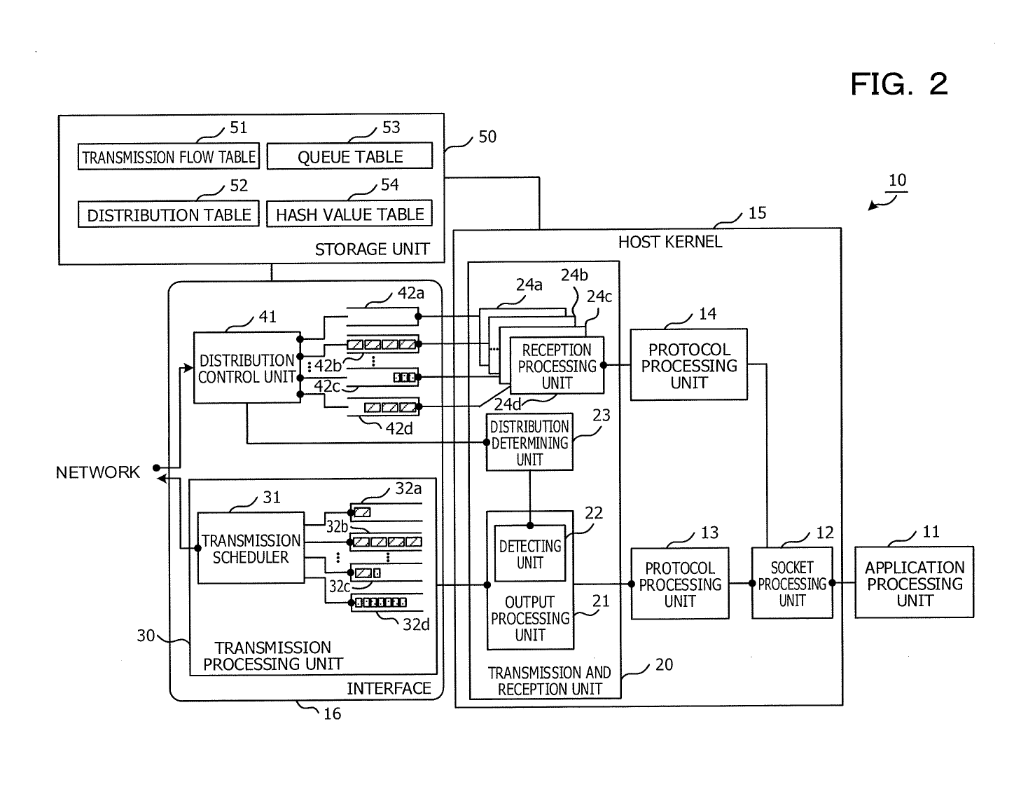

FIG. 2 illustrates an example of the structure of a communication apparatus 10. The communication apparatus 10 includes an application processing unit 11, a host kernel 15, an interface 16, and a storage unit 50. The host kernel 15 includes a socket processing unit 12, a protocol processing unit 13, a protocol processing unit 14, and a transmission and reception unit 20. The transmission and reception unit 20 includes an output processing unit 21, a detecting unit 22, a distribution determining unit 23, and reception processing units 24 (24a to 24d). The interface 16 includes a transmission processing unit 30, a distribution control unit 41, and receive queues 42 (42a to 42d). The transmission processing unit 30 includes a transmission scheduler 31 and transmission queues 32 (32a to 32d). The storage unit 50 stores a transmission flow table 51, a distribution table 52, a queue table 53, and a hash value table 54.

The application processing unit 11 executes an application that transmits data to and receives data from a communication destination. The socket processing unit 12 performs processing related to sockets used to perform communication. According to the protocol used in communication, the protocol processing unit 13 performs processing on data to be transmitted from the communication apparatus 10, after which the protocol processing unit 13 outputs the processed data to the output processing unit 21. The protocol processing unit 14 acquires packets from each of the reception processing units 24a to 24d and outputs data included in the packets to the socket processing unit 12. The protocol processing unit 13 may create packets to be transmitted from information about a flow through which data is to be transmitted and may output the created packets to the output processing unit 21. The communication apparatus 10 may be an apparatus having a function that reduces a transmission processing load by using TCP segmentation offload (TSO), generic segmentation offload (GSO), and the like. In this case, the protocol processing unit 13 outputs, to the output processing unit 21, data for a plurality of packets and information including information about the transmission flow.

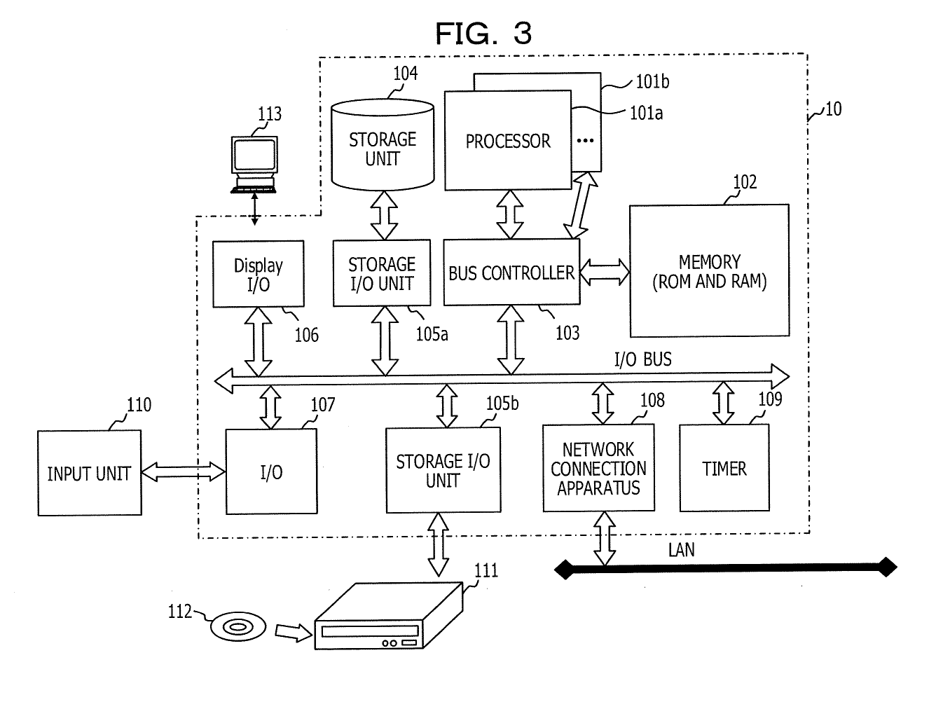

The output processing unit 21 receives packets entered from the protocol processing unit 13 and outputs the packets to one of the transmission queues 32a to 32d. The detecting unit 22 decides whether the amount of transmission data in the flow exceeds a predetermined value, with reference to information about the header of the packets output from the protocol processing unit 13 to the output processing unit 21 and to information about the flow. At that time, the detecting unit 22 may appropriately reference the transmission flow table 51. The transmission flow table 51 includes information that identifies flows transmitted from the communication apparatus 10 and information about, for example, the amount of transmitted data. If the detecting unit 22 detects a flow in which the amount of transmission data exceeds the predetermined value, the detecting unit 22 notifies the distribution determining unit 23 of information about the detected flow. The distribution determining unit 23 updates the distribution table 52 with reference to the queue table 53. The queue table 53 indicates processors (processors 101 in FIG. 3) by which the receive queues 42a to 42d are to be processed. The distribution table 52 includes information according to which packets received by the communication apparatus 10 are distributed to one of the receive queues 42a to 42d.

When the communication apparatus 10 receives packets, the received packets are entered into the distribution control unit 41. The distribution control unit 41 distributes the received packets to the receive queues 42a to 42d, with reference to the distribution table 52. If there is a packet for which a destination to which to distribute the packet is not recorded in the distribution table 52, the distribution control unit 41 distributes the packet to one of the receive queues 42a to 42d, with reference to the hash value table 54. The packets stored in the receive queues 42a to 42d are processed by the reception processing units 24a to 24d.

Although, in FIG. 2, four reception processing units 24, four transmission queues 32, and four receive queues 42 are illustrated, the communication apparatus 10 can include any number of reception processing units 24, any number of transmission queues 32, and any number of receive queues 42.

FIG. 3 illustrates an example of the hardware structure of the communication apparatus 10. The communication apparatus 10 includes processors 101 (101a and 101b), a memory 102, a bus controller 103, a storage unit 104, an input/output (I/O) bus, a network connection apparatus 108, and a timer 109. The communication apparatus 10 further includes storage I/O units 105 (105a and 105b), display I/O unit 106, and an I/O unit 107. The processor 101 may be an arbitrary processor including a central processing unit (CPU). Although, in FIG. 3, only two processors 101 are illustrated to simplify the drawing, any number of a plurality of processors 101 may be included in the communication apparatus 10. Even in a case in which only one processor 101 is included in the communication apparatus 10, if a plurality of processor cores are included in the processor 101 and each processor core processes one or more receive queues 42, the method according to the embodiment can be applied.

The processor 101 operates as the application processing unit 11 and host kernel 15. The processor 101 reads a program stored in the storage unit 104 at appropriate points and processes the program by using the memory 102 as a working memory. The processor 101 that processes one of the reception processing units 24 may be the same as or different from the processor that determines a processor intended to process acknowledgment packets. For example, although the processor 101a may operate as the processing unit 24a, processing by the detecting unit 22 and distribution determining unit 23 may be implemented by the processor 101b that does not operate as the reception processing unit 24. Alternatively, the processor 101a may operate as the detecting unit 22, distribution determining unit 23, and processing unit 24a. The memory 102 includes a random access memory (RAM) and a read only memory (ROM). The memory 102 works as the storage unit 50, transmission queues 32a to 32d, and receive queues 42a to 42d. The memory 102 also retains data used in processing by the processors 101 and data obtained as the result of processing by the processors 101. The transmission scheduler 31 and distribution control unit 41 are implemented by the processors 101 and network connection apparatus 108. The timer 109 may operate as part of the detecting unit 22.

The bus controller 103 interconnects the processors 101 and memory 102 so that data can be input and output. The storage I/O unit 105b connects an optical disk drive 111 to the communication apparatus 10 so that data can be input and output between them. The display I/O unit 106 connects a display 113 to the communication apparatus 10 so that data can be input and output between them. The I/O unit 107 connects an input unit 110 to the communication apparatus 10 so that data can be input and output between them. The optical disk drive 111 is used at appropriate points to read data from a portable storage medium 112 and to write data to the portable storage medium 112. The processors 101 may execute programs recorded on the portable storage medium 112.

### First Embodiment

By taking, as an example, a case in which the communication apparatus 10 has established a new flow to a remote apparatus, processing performed in a first embodiment will be described below by dividing the processing into “data transmission and detection of data transmission exceeding a predetermined amount”, “determination of a distribution rule for received packets”, and “reception processing by use of the distribution table 52”. In the example in the first embodiment, the communication apparatus 10 includes 10 processors 101, CPUs 0 to 9, and 10 receive queues 42, queues 0 to 9. The first embodiment also takes a case in which the communication apparatus 10 corresponds to TSO and GSO and transmission flow information included in data in a plurality of packets is output to the output processing unit 21. If the contents of a table vary with time, its reference numeral may be suffixed with an underscore followed by a numeral to indicate a point in time at which the state of the table was taken.

(1) Data Transmission and Detection of Data Transmission Exceeding a Predetermined Amount

For example, it is assumed that the communication apparatus 10 started a new data transmission through a flow identified by information indicated below.

Transmission source IP address: 192.168.1.13

Destination IP address: 10.111.33.14

Transmission source port number: 33415

Destination port number: 253

When the communication apparatus 10 starts processing of transmission to an apparatus on a network, the application processing unit 11 outputs transmission data to the output processing unit 21 through the socket processing unit 12 and protocol processing unit 13. The detecting unit 22 checks, for each flow, the amount of transmission data to be output by the output processing unit 21 to the transmission processing unit 30 to identify a flow in which the mount of transmission data is equal to or larger than a predetermined value. That is, in the first embodiment, the detecting unit 22 handles the amount of data to be transmitted as the amount of transmission data for each flow. If the detecting unit 22 detects a flow in which the mount of transmission data is equal to or larger than the predetermined value, the detecting unit 22 decides whether the flow is registered in the transmission flow table 51.

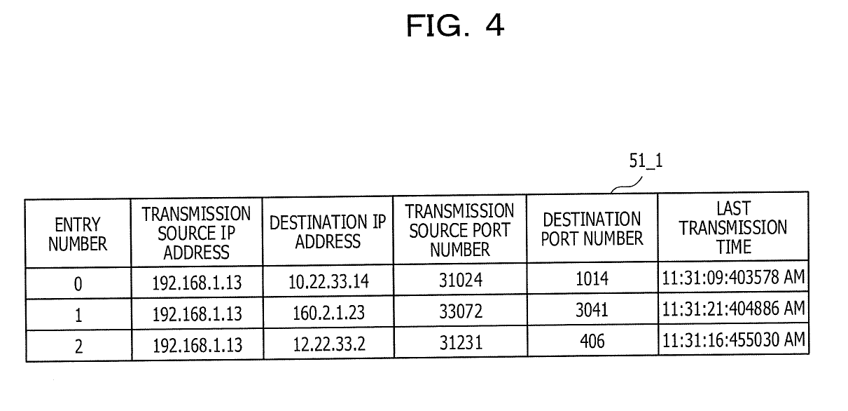

FIG. 4 illustrates an example of a transmission flow table 51_1. The transmission flow table 51_1 includes information about flows in which the mount of transmission data is equal to or larger than the predetermined value and for which a destination in which to store acknowledgment packets has been determined. In the transmission flow table 51_1, an entry number, a transmission source IP address, a destination IP address, a transmission source port number, a destination port number, and a last transmission time are recorded for each entry. A combination of the transmission source IP address, destination IP address, transmission source port number, and destination port number is used to identify a flow. The last transmission time is a time of the day at which the last packet was transmitted by the flow. The transmission flow table 51_1 excludes an entry for a flow that is transmitted from a port numbered 33415 at an IP address of 192.168.1.13 to a port numbered 253 at an IP address of 10.111.33.14. That is, a destination in which to store acknowledgment packets for TCP packets transmitted from the port numbered 33415 at the IP address of 192.168.1.13 to the port numbered 253 at the IP address of 10.111.33.14 has not yet been determined. Therefore, the detecting unit 22 notifies the distribution determining unit 23 that a transmission of a large amount of data has been detected and of information about a flow in which the transmission of a large amount of data has been detected. The detecting unit 22 also adds the information about the flow, of which the distribution determining unit 23 is notified, to the transmission flow table 51_1.

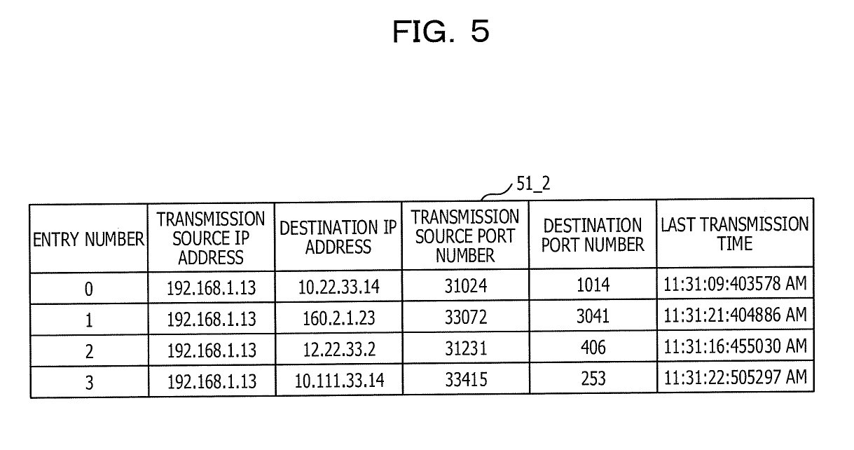

FIG. 5 illustrates an example of a transmission flow table 51_2. When a transmission of a large amount of data is detected, the detecting unit 22 updates the transmission flow table 51_1 to the transmission flow table 51_2. In the example in FIG. 5, information is recorded at an entry number of 3 about a flow destined from the port numbered 33415 at the IP address of 192.168.1.13 to the port numbered 253 at the IP address of 10.111.33.14.

Even in a case in which the detecting unit 22 detects a transmission of a large amount of data, if the transmission of a large amount of data is due to a flow that has been already registered in the transmission flow table 51, the detecting unit 22 does not notify the distribution determining unit 23, nor does it update the transmission flow table 51.

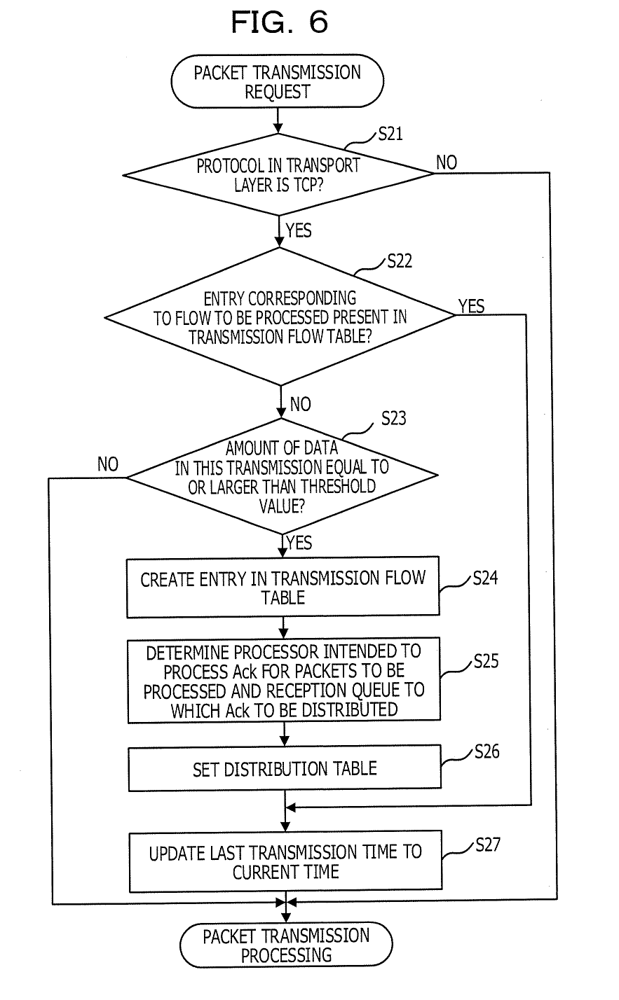

FIG. 6 is a flowchart that illustrates an example of processing performed by the communication apparatus 10 to transmit packets. The detecting unit 22 decides whether a protocol, in a transport layer, that is being used in communication to transmit a flow through which data has been entered into the output processing unit 21 is TCP (step S21). If the protocol used in the transport layer is not TCP, the detecting unit 22 terminates the processing (the result in step S21 is No).

Next, a case in which the communication apparatus 10 uses TCP to transmit packets will be described (the result in step S21 is Yes). The detecting unit 22 decides whether an entry corresponding to the flow under processing is present in the transmission flow table 51, with reference to information about the transmission source and destination of the flow (step S22). If an entry corresponding to the flow under processing is not present in the transmission flow table 51 (the result in step S22 is No), the detecting unit 22 decides whether the amount of data in this transmission is equal to or larger than a threshold value (step S23). If the amount of data in this transmission is equal to or larger than the threshold value (the result in step S23 is Yes), the detecting unit 22 creates an entry corresponding to the flow under processing in the transmission flow table 51 (step S24). The distribution determining unit 23 further determines a CPU that is intended to process acknowledgment (Ack) packets for packets to be transmitted and a receive queue 42 to which the acknowledgment packets are to be distributed (step S25). The distribution determining unit 23 sets the distribution table 52 according to its determination (step S26). In the transmission flow table 51, the detecting unit 22 updates, to the current time, the last transmission time associated with the flow in which the packets to be transmitted is included (step S27).

Now, a case in which it is decided that an entry corresponding to the flow under processing is present in the transmission flow table 51 will be described (the result in step S22 is Yes). In this case, the detecting unit 22 decides that processing concerning a flow in a direction opposite to the direction of the flow including the packets to be transmitted is registered in the distribution table 52. The detecting unit 22 then updates the last transmission time and terminates the processing (step S27). If the detecting unit 22 decides in step S23 that the amount of transmission data is smaller than the threshold value, the distribution determining unit 23 and detecting unit 22 terminates the processing.

(2) Determination of a Distribution Rule for Received Packets

When the distribution determining unit 23 is notified of the detection of a transmission of a large amount of data from the detecting unit 22, the distribution determining unit 23 determines a distribution rule in case of processing on a large amount of acknowledgment packets that are generated due to the transmission of a large amount of data and registers the determined distribution rule in the distribution table 52. Processing performed in determination of a distribution rule and its registration will be described below in detail.

First, the distribution determining unit 23 identifies processing loads on CPUs 0 to 9. To obtain a processing load on each of CPUs 0 to 9, a known method can be used. From CPUs 0 to 9, the distribution determining unit 23 selects the processor the smallest processing load as the processor intended to perform processing on acknowledgment packets.

Next, the distribution determining unit 23 references the queue table 53 and determines a receive queue 42 that is appropriate to store queues to assign the selected processor processing for the flow including acknowledgment packets for the flow of which the distribution determining unit 23 was notified by the detecting unit 22.

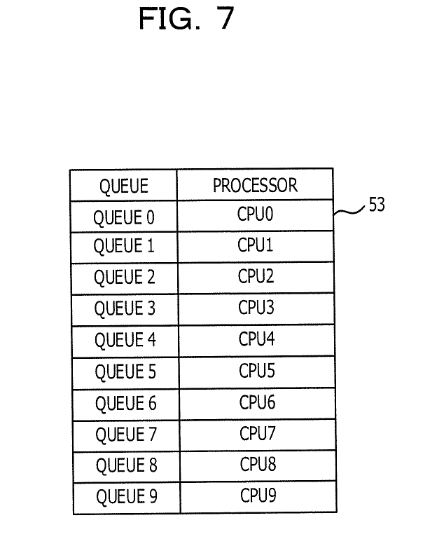

FIG. 7 illustrates an example of the queue table 53. For each of queues 0 to 9, the queue table 53 indicates a processor, included in the communication apparatus 10, that is intended to process packets stored in the queue. In the example in FIG. 7, packets stored in queue 0 are processed by CPU 0. Similarly, for the other queues, a CPU associated with the entry of a queue in the queue table 53 processes packets stored in the queue indicated in the entry. For example, packets stored in queue 1 are processed by CPU 1, packets stored in queue 2 are processed by CPU 2, and packets stored in queue 9 are processed by CPU 9.

For example, it is assumed here that, out of CPUs 0 to 9, the processing load on CPU 1 is smallest. In this case, the distribution determining unit 23 determines the use of queue 1 to have CPU 1 perform processing on a flow including acknowledgment packets for the flow of which the distribution determining unit 23 was notified by the detecting unit 22. In an acknowledgment packet for packets, which is to be transmitted, in a flow for which it was confirmed that the amount of transmission data exceeds a prescribed amount, the transmission source information and destination information change places. In an acknowledgment packet according to which a queue used as a distribution destination is determined, therefore, information about addresses and port numbers are as follows.

Transmission source IP address: 10.111.33.14

Destination IP address: 192.168.1.13

Transmission source port number: 253

Destination port number: 33415

The distribution determining unit 23 then updates the distribution table 52 by using a selected queue and identification information about the above acknowledgment packet to be stored in the selected queue.

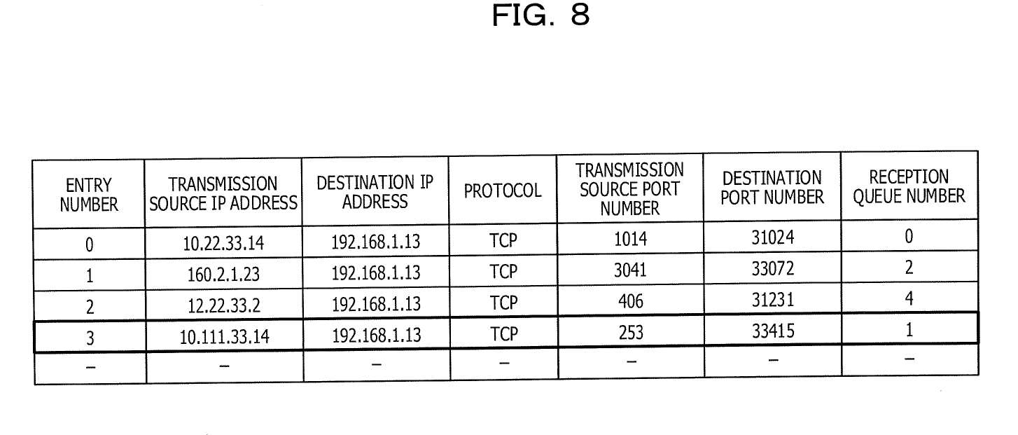

FIG. 8 illustrates an example of the distribution table 52. The distribution table 52 includes entry numbers, transmission source IP addresses, destination IP addresses, protocols, transmission source port numbers, destination port numbers, and receive queue numbers. Each entry number is a number used to identify an entry in the distribution table 52. In the distribution table 52, a combination of a transmission source IP address, a destination IP address, a transmission source port number, a destination port number, and a protocol is stored as a condition to extract acknowledgment packets for a flow through which a predetermined amount of data or more has been transmitted from the communication apparatus 10. The distribution determining unit 23 records the number of a receive queue 42 in which an acknowledgment packet identified by a combination of the transmission source IP address, destination IP address, transmission source port number, destination port number, and protocol, in correspondence to the combination.

As a result of processing described above with reference to, for example, FIGS. 4 to 7, the distribution determining unit 23 adds the condition at entry number 3 in FIG. 8 to the distribution table 52. The condition at entry number 3, which is enclosed by the bold lines in FIG. 8, is applied to acknowledgment packets for packets to be transmitted that are identified by entry number 3 in the transmission flow table 51_2 (see FIG. 5). That is, queue 1 includes a setting of a destination in which to store acknowledgment packets for TCP packets transmitted from the port numbered 253 at the IP address of 10.111.33.14 to the port numbered 33415 at the IP address of 192.168.1.13.

Similarly, the condition at entry number 0 in FIG. 8 was created so as to be applied to acknowledgment packets for packets to be transmitted that are identified by entry number 0 in the transmission flow table 51_2 (see FIG. 5). The condition at entry number 1 in FIG. 8 is applied to acknowledgment packets for packet to be transmitted that are identified by entry number 1 in the transmission flow table 51_2. The condition at entry number 2 in FIG. 8 is applied to acknowledgment packets for packets to be transmitted that are identified by entry number 2 in the transmission flow table 51_2.

In the distribution table 52, a protocol corresponding to packets under processing is specified as information that identifies acknowledgment packets. This is because the format of header information used to indentify a flow depends on a protocol and a protocol identifier is thereby used to identify the flow of packets.

(3) Reception Processing by Use of the Distribution Table 52

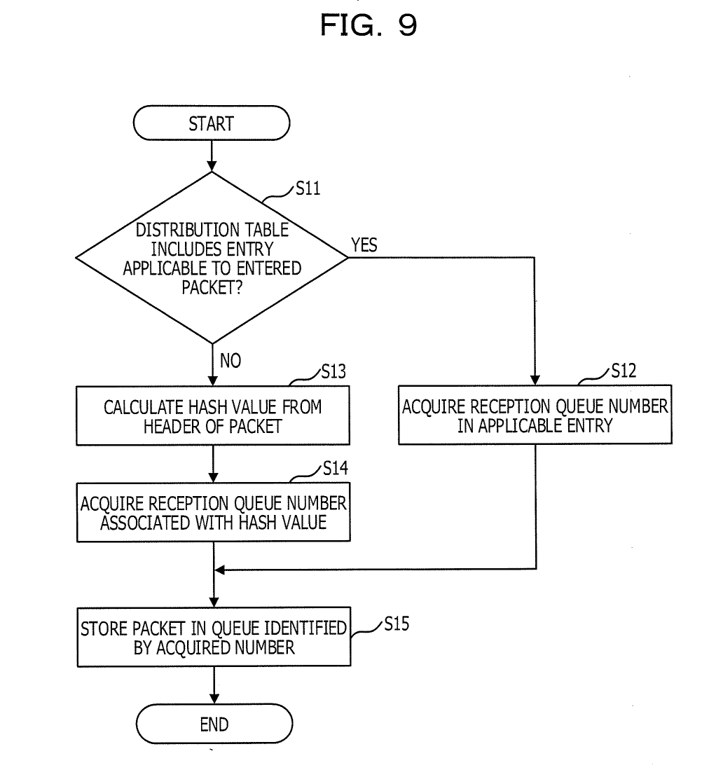

FIG. 9 is a flowchart that illustrates an example of processing performed by the communication apparatus 10 to receive packets. An example of reception processing in which the distribution table 52 is used and an example of packet processing that is not registered in the distribution table 52 will be described above with reference to FIG. 9.

In step S11, to select a receive queue 42 in which to store packets transmitted from another apparatus on the network, the distribution control unit 41 decides whether an entry applicable to a packet entered into the distribution control unit 41 is included in the distribution table 52. In this case, the distribution control unit 41 searches the distribution table 52 (see FIG. 8) by using a combination of the transmission source IP address, destination IP address, transmission source port number, destination port number, and protocol of the entered packet as a key. If the combination of the transmission source IP address, destination IP address, transmission source port number, destination port number, and protocol of the entered packet matches an entry in the distribution table 52 (the result in step S11 is Yes), the distribution control unit 41 acquires the receive queue number in the entry applicable to the entered packet (step S12). The distribution control unit 41 then stores the entered packet in the queue identified by the acquired number (step S15).

Next, a case will be described in which the combination of the transmission source IP address, destination IP address, transmission source port number, destination port number, and protocol of the packet entered into the distribution control unit 41 does not match any of the entries in the distribution table 52 (the result in step S11 is No). The distribution control unit 41 calculates a hash value from the header of the entered packet (step S13). In the calculation performed in step S13 to obtain a hash value, a hash function can be used.

In step S14, the distribution control unit 41 acquires, from the hash value table 54, a receive queue number associated with the hash value calculated in step S13 by using the header of the entered packet. The distribution control unit 41 then stores the entered packet in a queue identified by the acquired number (step S15).

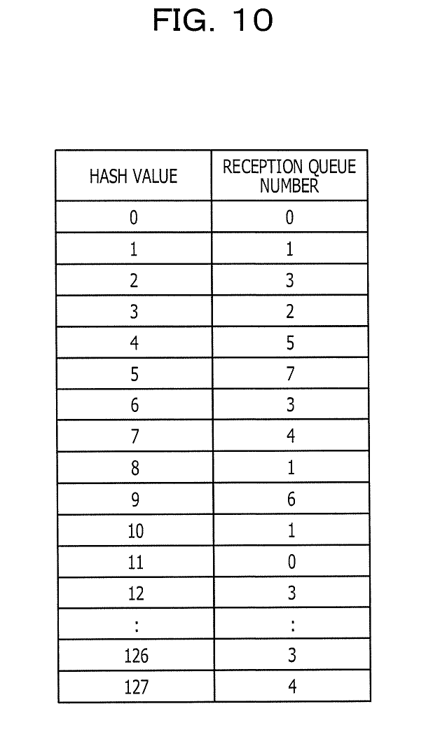

FIG. 10 illustrates an example of the hash value table 54. The hash value table 54 holds the numbers of receive queues 42 used to store packets in correspondence to hash values obtained from the headers of packets. In the hash value table 54 illustrated in FIG. 10, for example, queue 1 is set as the destination in which to store a packet for which the hash value obtained from the header is 1, and queue 7 is set as the destination in which to store a packet for which the hash value is 5.

As a result of processing described above with reference to FIGS. 9 and 10, packets are stored in receive queues 42. After that, the reception processing unit 24 reads out a packet from a receive queue 42 that is preset as a target in reception processing and performs reception processing. The reception processing unit 24 outputs a packet obtained in reception processing to the protocol processing unit 14. The application processing unit 11 acquires data included in the packet received through the protocol processing unit 14 and socket processing unit 12.

As described above, in the first embodiment, when packets transmitted in a protocol involving an acknowledgment are included in a flow in a direction opposite to the direction of a flow through which a predetermined amount mount of data or more is transmitted by the communication apparatus 10, a receive queue 42 in which to store the packets is determined by using a condition in the distribution table 52. In a flow in a direction opposite to the direction of a flow in which a large mount of data is transmitted, a large amount of acknowledgment packets without data are highly likely to be transmitted. Therefore, a packet that has been distributed according to the distribution table 52 is highly likely to be an acknowledgment packet for packets that have been transmitted from the communication apparatus 10. This enables the communication apparatus 10 to select flows due to which a large amount of acknowledgment packets are highly likely to be received and then assign processing on the selected flows to processors with a low load.

As described above with reference to steps S11 and S13 to S15, as for a flow due to which a large amount of acknowledgment packets are less likely to be received, receive queues 42 are selected by using hash values, without registration in the distribution table 52. Therefore, the communication apparatus 10 can reduce the number of distribution rules retained in the communication apparatus 10 and efficiently perform processing for a flow due to which a large amount of acknowledgment packets are likely to be received.

### Second Embodiment

In a second embodiment, a case will be described in which the distribution determining unit 23 assigns processing on acknowledgment packets predicted to be received from a transmission destination as a result of a transmission of a large amount of data to the processor 101 that has performed transmission processing on the data. When processing on acknowledgment packets is assigned to a processor that has performed data transmission processing, it can be expected that efficient processing by an improved cache hit rate, a reduction in an overhead in inter-processor communication, and the like will be achieved and that processing of an application that performs communication will not affect other processing. In the second embodiment as well, detection of a transmission of a predetermined amount of data or more and reception processing by using the distribution table 52 are performed as in the first embodiment.

If the detecting unit 22 identifies, in processing as described in the first embodiment, a flow through which a predetermined amount of data or more has been transmitted in a protocol that involves acknowledgment, the detecting unit 22 decides whether the distribution table 52 includes a registration about a flow in a direction opposite to the direction of the transmission flow. If the distribution table 52 includes no registration about a flow in the opposite direction, the detecting unit 22 requests the distribution determining unit 23 to update the distribution table 52. Then, the distribution determining unit 23 identifies the processor that has performed transmission processing on the flow.

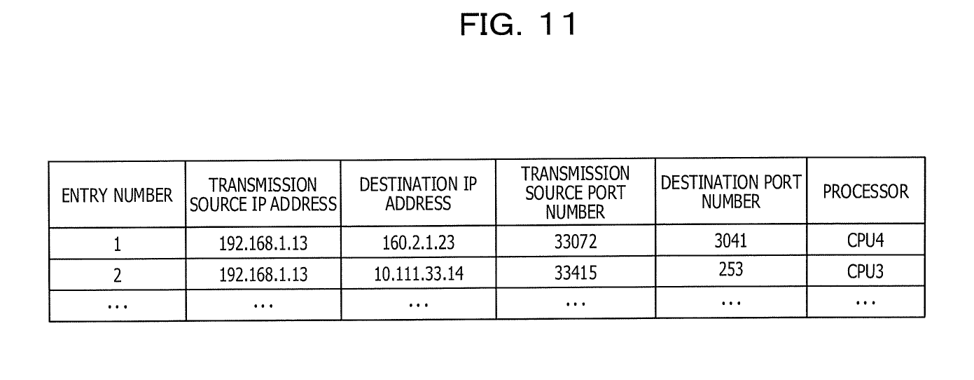

FIG. 11 illustrates an example of information used to identify a processor that has performed transmission processing for a flow. In the table illustrated in FIG. 11, a combination of a transmission source IP address, destination IP address, transmission source port number, and destination port number of each flow is associated with the identifier of the processor 101 that is executing processing in which data to be transmitted in the flow is used. In an implementation of an actual operating system, a combination of a plurality of tables rather than a simple table of this type is generally referenced. To simplify the description, however, a table as illustrated in FIG. 11 is assumed.

The distribution determining unit 23 uses information illustrated in FIG. 11 to identify the processor 101 that had performed processing to transmit a flow through which a predetermined amount of data or more has been transmitted. For example, it is assumed that the amount of data transmitted from the port numbered 33415 at the IP address of 192.168.1.13 to the port numbered 253 at the IP address of 10.111.33.14 is identified as exceeding the predetermined amount. If information as illustrated in FIG. 11 is stored in the communication apparatus 10, the information indicates that data in the flow that has been subject to data transmission processing had been created in processing performed by CPU 3. Therefore, to have CPU 3 process acknowledgment packets for packets in the flow that has been subject to data transmission processing, the distribution determining unit 23 references the queue table 53 (see FIG. 7) and determines queue 3 as the destination in which to store the acknowledgment packets.

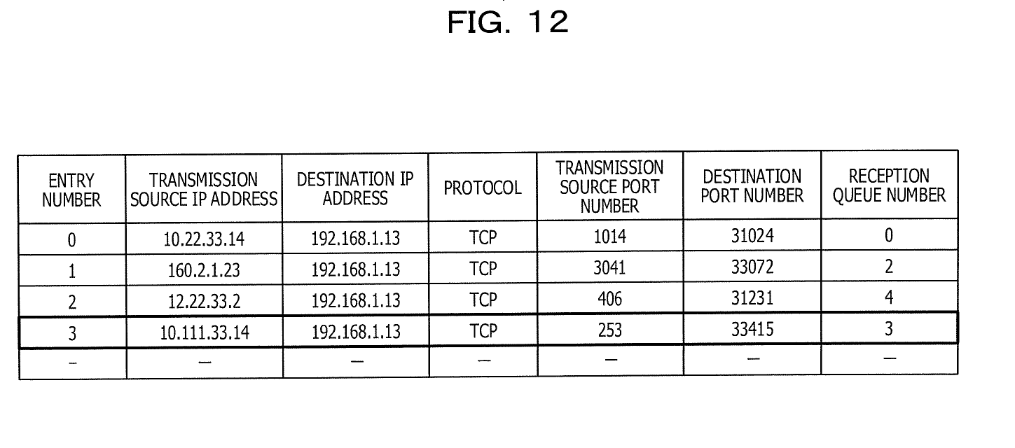

FIG. 12 illustrates an example of the distribution table 52. In the example in FIG. 12, the distribution table 52 has been updated by the distribution determining unit 23 as a result of the processing described above with reference to FIG. 11. At entry number 3 in the distribution table 52 illustrated in FIG. 11, it is recorded that packets in a flow destined from the port numbered 253 at the IP address of 10.111.33.14 to the port numbered 33415 at the IP address of 192.168.1.13 will be stored in queue 3. That is, it is registered that acknowledgment packets for a flow destined from the port numbered 33415 at the IP address of 192.168.1.13 to the port numbered 253 at the IP address of 10.111.33.14 to transmit a large amount of data will be stored in queue 3. Processing performed by the distribution determining unit 23 to update the distribution table 52 is as described in the first embodiment.

As described above, when a destination in which to store acknowledgment packets is determined, a processing load, on a processor 101, that is involved in reception of a large amount of acknowledgment packets is distributed to the processor 101 that performs processing on a session related to packets for which a notification of the reception of them has been made with acknowledgment packets. Therefore, due to efficient processing and localized execution of an application that performs communication, it can be expected that other processing will not be affected.

### Third Embodiment

In a third embodiment, a modification of the method of detecting a data transmission in which the amount data exceeds a predetermined amount will be described. In the third embodiment, to decide whether there is a transmission of a large amount of data, the total amount of data is observed that is consecutively transmitted within a predetermined time interval in response to a plurality of transmission requests with which the application processing unit 11 has requested transmissions. Processing to determine a rule according to which received packets are distributed and reception processing in which the distribution table 52 is used are as in the first or second embodiment.

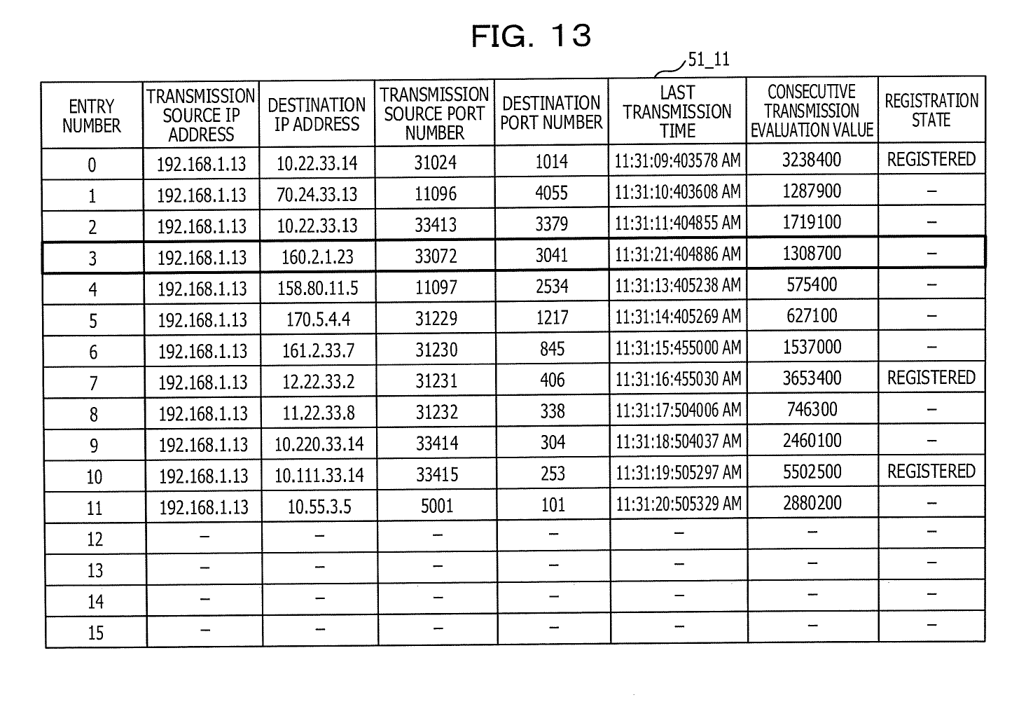

FIG. 13 illustrates an example of a transmission flow table 51_11 according to the third embodiment. Each entry in the transmission flow table 51_11 in FIG. 13 includes an entry number, a transmission source IP address, a destination IP address, a transmission source port number, a destination port number, a last transmission time, a consecutive transmission evaluation value, and a registration state. The transmission source IP address, destination IP address, transmission source port number, destination port number, and last transmission time are as described in the first embodiment with reference to FIG. 4. The consecutive transmission evaluation value is a value used in a decision as to whether the amount of data transmitted through the relevant flow exceeds a predetermined amount. In the following description of the consecutive transmission evaluation value, a case will be taken as an example in which the total amount of data transmitted in response to transmission requests with which the application processing unit 11 has requested transmissions within a predetermined time interval. The registration state indicates whether a rule used in the distribution of acknowledgment packets for packets transmitted in the relevant flow has been registered.

For example, information about addresses and ports used in a new flow transmitted by the communication apparatus 10 is as follows.

Transmission source IP address: 192.168.1.13

Destination IP address: 160.2.1.23

Transmission source port number: 33072

Destination port number: 3041

Data to be transmitted is output to the output processing unit 21.

For a flow through which data that has been entered into the output processing unit 21 is transmitted, the detecting unit 22 identifies a transmission source IP address, a destination IP address, a transmission source port number, and a destination port number, and decides whether a combination of the transmission source IP address, destination IP address, transmission source port number, and destination port number is registered in the transmission flow table 51. If an entry that includes the combination of the transmission source IP address, destination IP address, transmission source port number, and destination port number is not included in the transmission flow table 51, the detecting unit 22 creates a new entry. In this embodiment, a large amount of transmission is not decided only in one piece of transmission processing, so an entry is created in a case as well in which a distribution rule is not created. In the transmission flow table 51_11 illustrated in FIG. 13, information about a newly transmitted flow is added as entry number 3. For the newly added entry, the detecting unit 22 sets the amount of data intended to be subject to transmission processing this time as the consecutive transmission evaluation value. If the amount of data intended to be subject to transmission processing this time does not exceed a predetermined value, the detecting unit 22 sets, as the registration state, information indicating that a registration has not been made. In the example below, it is assumed that 1,308,700 bytes of data has been transmitted through a flow destined from the port numbered 33072 at the IP address of 192.168.1.13 to the port numbered 3041 at the IP address of 160.2.1.23.

It is also assumed that after that, data transmission has been continued through a flow destined from the port numbered 33072 at the IP address of 192.168.1.13 to the port numbered 3041 at the IP address of 160.2.1.23. When transmission processing is performed through a flow the entry of which is already in the transmission flow table 51, the detecting unit 22 compares a time interval during which data is transmitted through the flow under processing with a threshold value. Specifically, the detecting unit 22 decides whether a time duration from the previous transmission time for a transmission flow of data under processing to a transmission time for new data to be transmitted is shorter than a threshold Tht.

The threshold Tht is, for example, a time interval that, even if a transmission request is made for each packet, may affect processing on an acknowledgment packet for transmission data. The threshold Tht may be changed depending on, for example, the performance of the processor 101 used in the communication apparatus 10.

If the time duration from the previous transmission time for a transmission flow of data under processing to a transmission time for new data to be transmitted is shorter than the threshold Tht, the detecting unit 22 decides that a processing load on acknowledgment packets will be cumulatively increased due to transmission processing performed this time. Thus, the detecting unit 22 adds the amount of data to be transmitted in response to a transmission request issued this time to the consecutive transmission evaluation value.

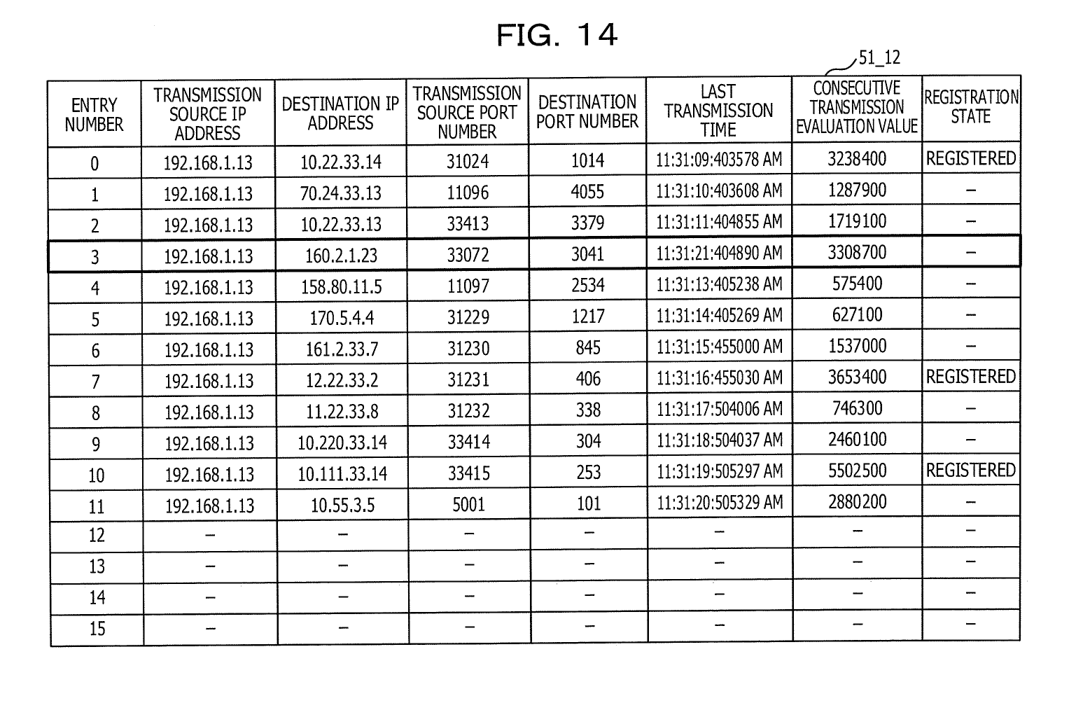

FIG. 14 illustrates an example of a transmission flow table 51_12 according to the third embodiment. The example in FIG. 14 illustrates a case in which a transmission request was issued from the port numbered 33072 at the IP address of 192.168.1.13 to the port numbered 3041 at the IP address of 160.2.1.23 at 11:31:21.404890 am. In this example, the amount of data requested to be transmitted is 2,000,000 bytes. The threshold Tht will be assumed to be 5 microseconds. When the detecting unit 22 recognizes that a transmission request was issued, the detecting unit 22 obtains an elapsed time from the previous transmission request to the transmission request issued this time. In this example, the elapsed time from the previous transmission request to the transmission request issued this time is 4 microseconds. Since the threshold Tht is 5 microseconds, two transmission requests were issued in a time interval shorter than the threshold Tht. Thus, the detecting unit 22 changes the last transmission time to the time for the transmission request issued this time. The detecting unit 22 further updates the consecutive transmission evaluation value to the sum of a value (1,308,700 bytes) obtained when the previous transmission request was processed and the amount of data (2,000,000 bytes) that is currently requested to be transmitted. Accordingly, the transmission flow table 51_11 is updated to the transmission flow table 51_12.

Upon the completion of the update of the transmission flow table 51, the detecting unit 22 compares the consecutive transmission evaluation value with a predetermined amount (threshold Th). If the consecutive transmission evaluation value is smaller than the threshold Th, the detecting unit 22 decides that a large amount of data has not been transmitted. When it is decided that a large amount of data has not been transmitted, a distribution rule for acknowledgment packets for the flow under processing is not registered, so processing related to the flow under processing is terminated.

Now, a case in which the consecutive transmission evaluation value is equal to or larger than the threshold Th will be described. It will be assumed that, in the third embodiment, the threshold Th is, for example, 3,000,000 bytes. In this case, the consecutive transmission evaluation value in the entry numbered 3 in FIG. 14 exceeds the threshold Th. Thus, the detecting unit 22 references the registration state in the transmission flow table 51_12 to decide whether the distribution table 52 includes a condition used in processing on acknowledgment packets for transmitted packets in the flow in which a large amount of data was detected. In the transmission flow table 51_12 in FIG. 14, the registration state in the entry numbered 3 indicates a value representing that a registration has not been made. Thus, the detecting unit 22 notifies the distribution determining unit 23 that a transmission of a large amount of data has been detected and of information about a flow in which the transmission of a large amount of data has been detected. Then, a distribution rule for received packets is determined as in the first embodiment.

Upon the termination of the update of the distribution table 52 related to the flow of which the distribution determining unit 23 was notified by the detecting unit 22, the distribution determining unit 23 notifies the detecting unit 22 that registration in the distribution table 52 has been terminated. The detecting unit 22 changes the registration state in the entry for which the detecting unit 22 was notified that registration in the distribution table 52 has been terminated to a value indicating that registration has been made.

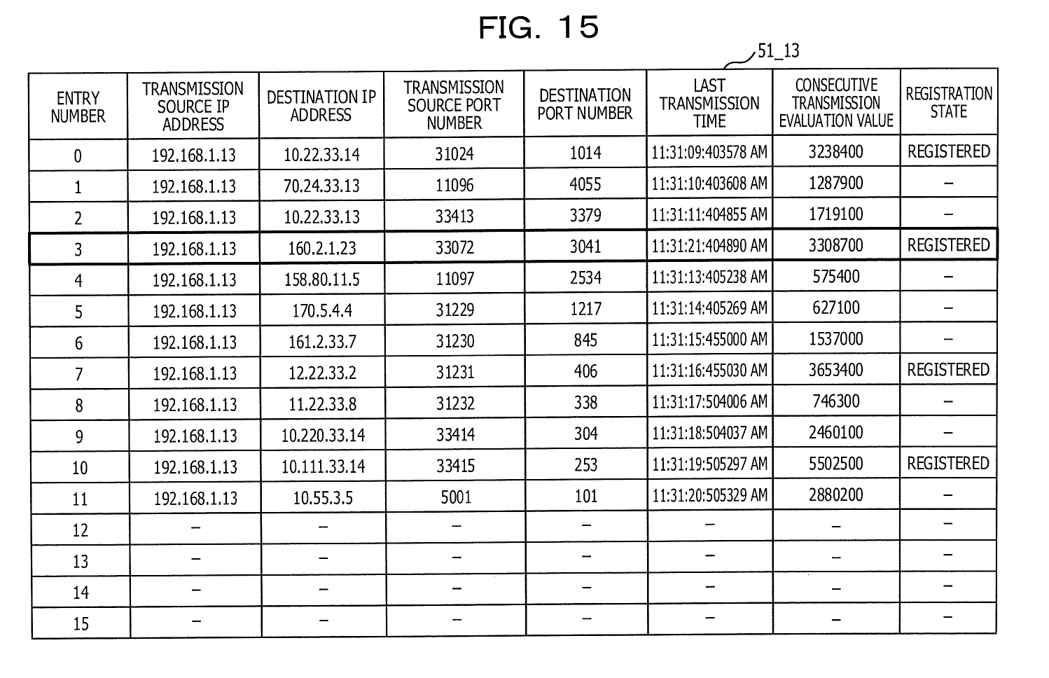

FIG. 15 illustrates an example of a transmission flow table 51_13 according to the third embodiment. When, for example, a destination in which to store acknowledgment packets destined from the port numbered 3041 at the IP address of 160.2.1.23 to the port numbered 33072 at the IP address of 192.168.1.13 has been determined, the detecting unit 22 updates the registration state in the entry numbered 3 accordingly. Therefore, the transmission flow table 51_12 is updated to the transmission flow table 51_13 by the detecting unit 22.

Even in a case in which the detecting unit 22 detects a transmission of a large amount of data, if the transmission of a large amount of data is due to a flow for which processing has been registered in the distribution table 52, such as a flow in the entry numbered 0, the detecting unit 22 does not notify the distribution determining unit 23.

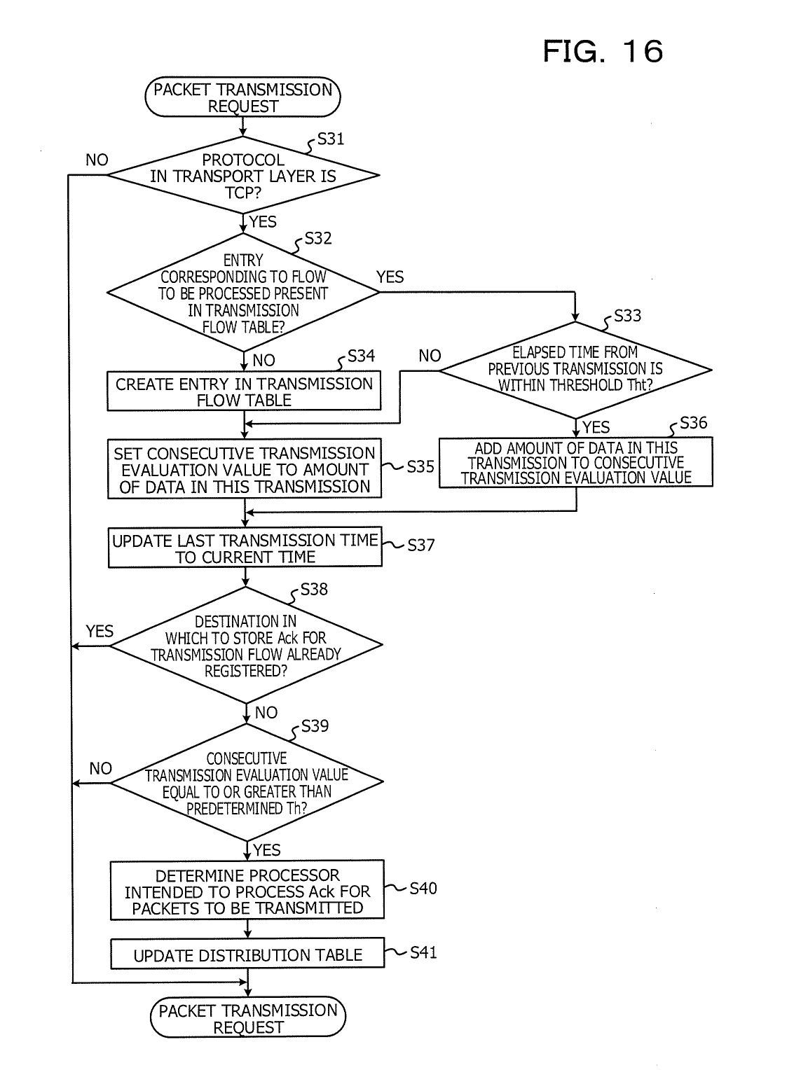

FIG. 16 is a flowchart that illustrates an example of processing, according to the third embodiment, performed by the communication apparatus 10. The detecting unit 22 decides whether a protocol, in a transport layer, that is being used in communication to transmit a flow through which data has been entered into the output processing unit 21 is TCP (step S31). If the communication apparatus 10 uses TCP to transmit packets (the result S31 is Yes), the detecting unit 22 decides whether an entry corresponding to a flow under processing is included in the transmission flow table 51, with reference to information about the transmission source and destination of the flow (step S32). If there is no entry corresponding to the flow under processing in the transmission flow table 51 (the result in step S32 is No), the detecting unit 22 creates an entry corresponding to the flow under processing in the transmission flow table 51 (step S34). The detecting unit 22 also sets the consecutive transmission evaluation value to the amount of data in this transmission (step S35).

If there is an entry corresponding to the flow under processing in the transmission flow table 51 (the result in step S32 is Yes), the detecting unit 22 decides, for the flow under processing, whether an elapsed time from the previous transmission is within the threshold Tht (step S33). If the elapsed time from the previous transmission is within the threshold Tht (the result in step S33 is Yes), the detecting unit 22 adds the amount of data in this transmission to the consecutive transmission evaluation value (step S36). If the elapsed time from the previous transmission exceeds the threshold Tht (the result in step S33 is No), the detecting unit 22 sets the consecutive transmission evaluation value to the amount of data in this transmission (step S35). That is, it can be said that when the data transmission interval exceeds the threshold Tht, the detecting unit 22 resets the consecutive transmission evaluation value.

Upon the completion of step S35 or S36, the detecting unit 22 updates the last transmission time for the flow under processing to the current time (step S37). Next, the detecting unit 22 decides whether a destination in which to store acknowledgment packets (Ack) for the transmission flow under processing is already registered (step S38). If a destination in which to store acknowledgment packets is already registered (the result in step S38 is Yes), the detecting unit 22 terminates the processing.

If a destination in which to store acknowledgment packets (Ack) has not been registered (the result in step S38 is No), the detecting unit 22 decides whether the consecutive transmission evaluation value is equal to or greater than the predetermined Th (step S39). If the consecutive transmission evaluation value is equal to or greater than the predetermined Th (the result in step S39 is Yes), the distribution determining unit 23 determines a processor 101 intended to process acknowledgment packets for packets to be transmitted and updates the distribution table 52 accordingly (steps S40 and S41). If the consecutive transmission evaluation value is smaller than the predetermined Th (the result in step S39 is No), the detecting unit 22 terminates the processing. If the protocol used in the transport layer is not TCP (the result in step S31 is No), the detecting unit 22 terminates the processing.

In the third embodiment, the consecutive transmission evaluation value is the sum of data transmitted in a transmission interval within the threshold Tht. In the third embodiment, therefore, even in a case in which the communication apparatus 10 does not reduce a transmission processing load by using TSO, GSO, and the like, if the amount of transmission data exceeds a predetermined value due to consecutive transmission of packets, a distribution rule for acknowledgment packets is set. For example, it is assumed that a transmission request is made for each packet in a communication apparatus 10 that has neither TSO nor GSO and 1,460 bytes of data is included in one packet. Even in this case, if 2,055 packets are transmitted in a transmission interval shorter than the threshold Tht, the continuous transmission evaluation value is 3,000,300 bytes. Therefore, if the threshold Th is 3,000,000 bytes, when 2055 packets are consecutively transmitted, a destination in which to store acknowledgment packets is determined.

When a transmission request is made for each packet, the communication apparatus 10 may receive an acknowledgment packet for part of packets to be transmitted before a receive queue 42 in which to store acknowledgment packets is determined. Therefore, another processor 101 may process subsequent acknowledgment packets, the other processor 101 being different from the processor 101 that has processed an acknowledgment packet before a receive queue 42 in which to store received packets is determined. An order in which packets are subject to reception processing may differ from the order in which the packets have been transmitted, depending on the load on the processor 101 that processes acknowledgment packets. In the third embodiment as well, however, the probability that data is included in acknowledgment packets for a flow through which data is transmitted is low as in the first and second embodiments. Even if the processing order is changed, this does not easily involve retransmission processing, nor does it cause a reduction in communication speed.

In the third embodiment as well, even in a case in which the communication apparatus 10 uses TSO and GSO to perform processing, it is possible to control the receive queue 42 in which to store acknowledgment packets and the processor 101 intended to process the acknowledgment packet, as in the first and second embodiments.

### Fourth Embodiment

As described in the third embodiment, when the continuous transmission evaluation value is used, a processor 101 intended to process received packets and a receive queue 42 can be determined by using the amount of transmission data corresponding to a plurality of transmission requests. The method of calculating the continuous transmission evaluation value is not limited to the method described in the third embodiment. In the fourth embodiment, processing used to calculate the continuous transmission evaluation value according to the leaky bucket algorithm will be described as an example.

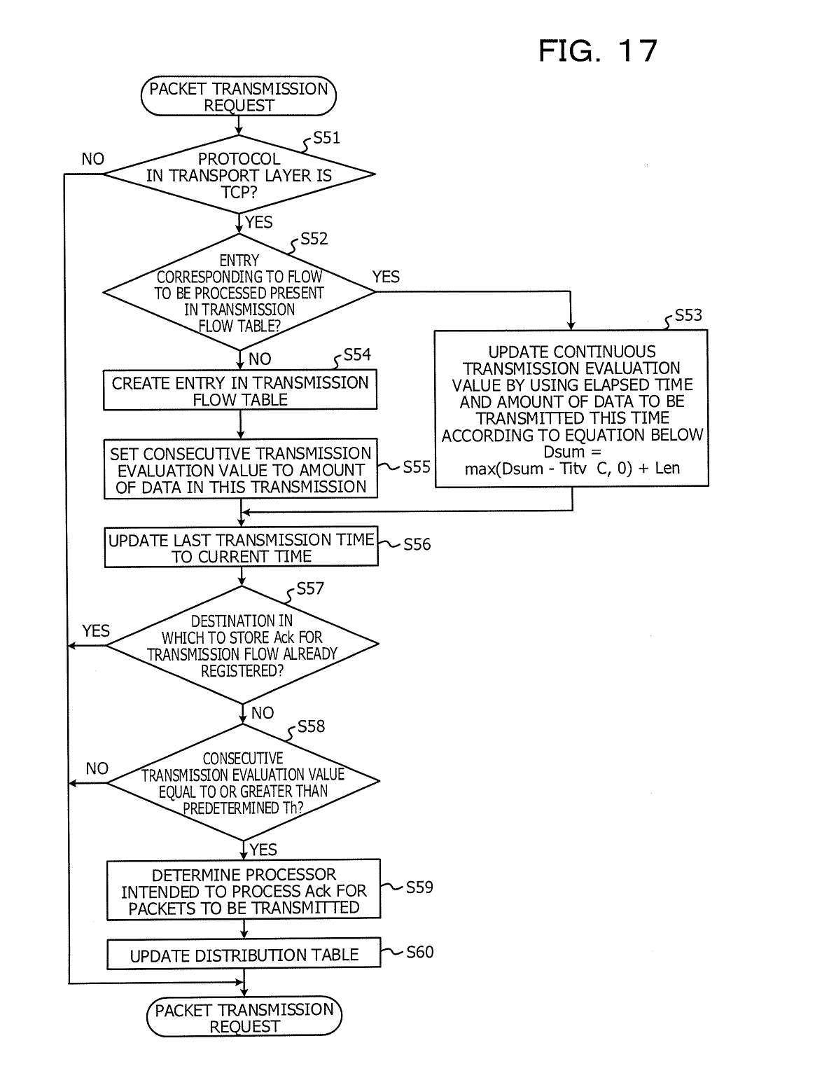

FIG. 17 is a flowchart that illustrates an example of processing, according to the fourth embodiment, performed by the communication apparatus 10. The detecting unit 22 decides whether a protocol, in a transport layer, that is being used in communication to transmit a flow through which data has been entered into the output processing unit 21 is TCP (step S51). If the communication apparatus 10 uses TCP to transmit packets (the result S51 is Yes), the detecting unit 22 decides whether an entry corresponding to a flow under processing is included in the transmission flow table 51, with reference to information about the transmission source and destination of the flow (step S52).

A case will be described below in which an entry corresponding to a flow under processing is included in the transmission flow table 51 (the result in step S52 is Yes). The detecting unit 22 updates the continuous transmission evaluation value for the flow under processing by using the amount of transmission data processed in response to a transmission request issued this time to perform a calculation according to the equation blow (step S53).

V=max(Dsum−Tintv×C,0)+Len

where V is the calculation result of the consecutive transmission evaluation value, Dsum is the calculation result of the consecutive transmission evaluation value obtained in previous transmission processing, Tintv is an elapsed time from the previous transmission processing to transmission processing performed this time, and C is an amount per unit time by which data that has been transmitted from the communication apparatus 10 and for which an acknowledgment packet has not been received is reduced. The value of C is determined by using the performance of the processor 101 used in the communication apparatus 10, a round-trip time (RTT) between the communication apparatus 10 and the data transmission destination, a communication speed on the line between the communication apparatus 10 and the data transmission destination, and the like. Len is the amount of data that has been transmitted in response to a transmission request in transmission processing performed this time. The max function indicates the maximum value of a plurality of values enclosed in parentheses. If the calculated value of “Dsum−Tintv×C” is positive, “max(Dsum−Tintv×C, 0)” is “Dsum−Tintv×C”. If the calculated value of “Dsum−Tintv×C” is negative, “max(Dsum−Tintv×C, 0)” is 0.

Processing in steps S54 to S60 is the same as processing performed in steps S34, S35, and S37 to S41, which have been described above with reference to FIG. 16.

In the fourth embodiment, the consecutive transmission evaluation value is determined by a calculation in step S53, according to an increase in the amount of data transmitted from the communication apparatus 10 and an increase in the amount of data for which acknowledgment packets have been received by the communication apparatus 10. The consecutive transmission evaluation value is an index as to whether a processor 101 intended to process acknowledgment packets is determined, so, in the fourth embodiment, it can also be said that a processor 101 intended to process acknowledgment packets is determined according to the amount of transmission data for which acknowledgment packets have not been received.

When the consecutive transmission evaluation value based on the length of time between two pieces of transmission processing is used as in the fourth embodiment, a load in reception processing caused by acknowledgment packets can be precisely estimated. Therefore, if the fourth embodiment is applied to communication with a large RTT, the communication apparatus 10 can precisely identify a load in reception processing.

### Fifth Embodiment

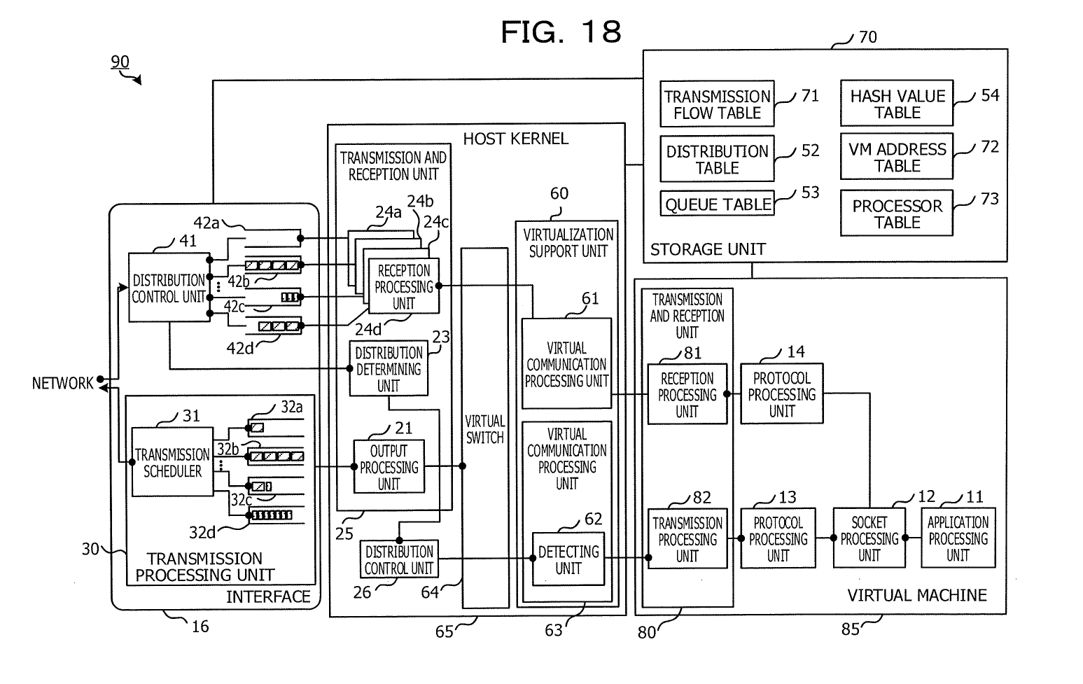

FIG. 18 illustrates an example of the structure of a communication apparatus 90 that operates a virtual machine. In the fifth embodiment, a case will be described as an example in which a processor 101 with a low processing load is assigned processing on acknowledgment packets, which would otherwise be performed as the operation of the communication apparatus 90 in which a virtual machine (VM) 85 is operating.

The communication apparatus 90 includes

the interface 16, a host kernel 65, a storage unit 70, and the virtual machine 85. The host kernel 65 includes a transmission and reception unit 25, a distribution control unit 26, a virtualization support unit 60, and a virtual switch 64. The transmission and reception unit 25 includes the output processing unit 21, distribution determining unit 23, and reception processing units 24 (24a to 24d). The virtualization support unit 60 includes a virtual communication processing unit 61 and a virtual communication processing unit 63. The virtual communication processing unit 63 includes a detecting unit 62. The virtual machine 85 includes a transmission and reception unit 80, the application processing unit 11, the socket processing unit 12, the protocol processing unit 13, and the protocol processing unit 14. The transmission and reception unit 80 includes a reception processing unit 81 and a transmission processing unit 82. The storage unit 70 includes a transmission flow table 71, the distribution table 52, the queue table 53, the hash value table 54, and a VM address table 72. The storage unit 70 may optionally hold a processor table 73. Processing performed in the application processing unit 11, socket processing unit 12, protocol processing unit 13, protocol processing unit 14, interface 16, output processing unit 21, and reception processing units 24 are the same as in one of the first, third, and fourth embodiments. The distribution table 52, queue table 53, and hash value table 54 are also the same as in one of the first, third, and fourth embodiments.

The transmission processing unit 82 receives data entered from the protocol processing unit 13 and outputs the data to the virtual communication processing unit 63. The detecting unit 62 decides whether a predetermined amount of data or more has been transmitted, according to the amount of data entered into the virtual communication processing unit 63. The decision method used in the detecting unit 62 may be the same as in detection processing performed by the detecting unit 22 in one of the first, third, and fourth embodiments. When the detecting unit 62 uses the consecutive transmission evaluation value to decide whether a large amount of data has been transmitted, the detecting unit 62 references the transmission flow table 71 at appropriate points.

The communication apparatus 90 is also implemented by hardware illustrated in FIG. 3. The processor 101 executes processing by the virtual machine 85 and host kernel 65. The memory 102 works as the storage unit 70, transmission queues 32 (32a to 32d), and receive queues 42 (42a to 42d). The transmission scheduler 31 and distribution control unit 41 are implemented by the processors 101 and network connection apparatus 108.

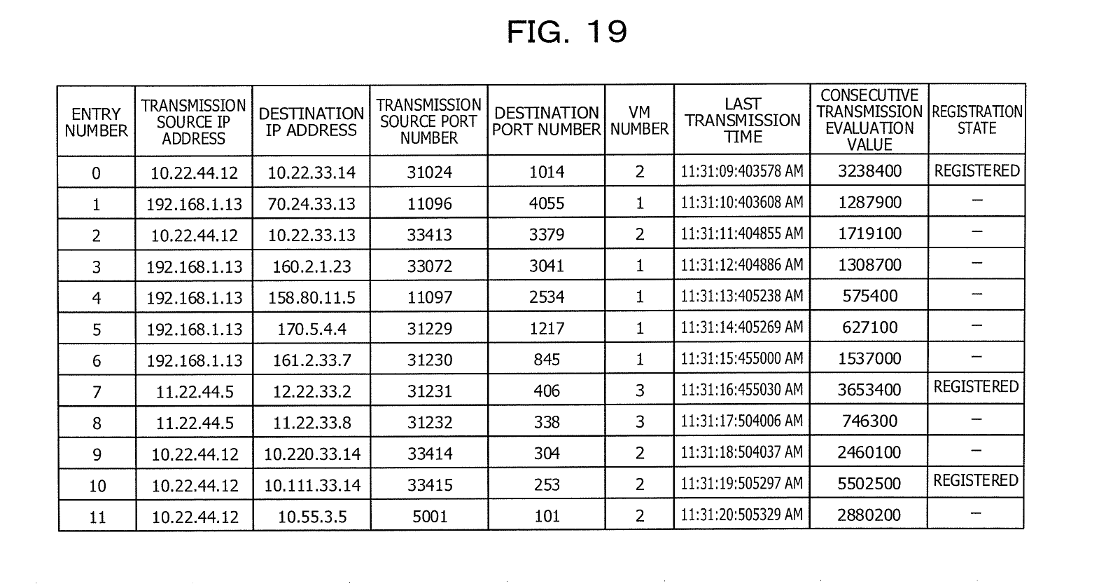

FIG. 19 illustrates an example of the transmission flow table 71. The transmission flow table 71 includes, for each entry, an entry number, a transmission source IP address, a destination IP address, a transmission source port number, a destination port number, a VM number, a last transmission time, a consecutive transmission evaluation value, and a registration state. The entry number, transmission source IP address, destination IP address, transmission source port number, destination port number, last transmission time, consecutive transmission evaluation value, and registration state are the same as in the third and fourth embodiments. The VM number is identification information that identifies the virtual machine 85 that is performing transmission processing on a flow recorded as an entry. If the detecting unit 62 detects a transmitted flow that is not registered in the transmission flow table 71, the detecting unit 62 registers information about the detected flow in the transmission flow table 71. At that time, the detecting unit 62 identifies the virtual machine 85 that is performing processing on the flow with reference to the VM address table 72.

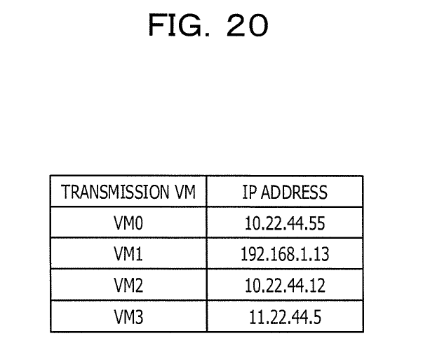

FIG. 20 illustrates an example of the VM address table 72. In the VM address table 72, IP addresses used in communication performed by virtual machines 85 are associated with identification information that identifies the virtual machines 85. For example, a virtual machine (VM 0) with a VM number of 0 uses an IP address of 10.22.44.55. Similarly, a virtual machine (VM 1) with a VM number of 1 uses an IP address of 192.168.1.13, a virtual machine (VM 2) with a VM number of 2 uses an IP address of 10.22.44.12, and a virtual machine (VM 3) with a VM number of 3 uses an IP address of 11.22.44.5. The detecting unit 62 searches for the VM address table 72 by using the transmission source address of the detected flow as a key, and identifies the virtual machine that is processing the transmitted flow.

The detecting unit 62 identifies a flow through which a large amount of data was transmitted with reference to the transmission flow table 71 and notifies the distribution control unit 26 that a flow through which a large amount of data was transmitted has been detected together with information about the flow. The distribution control unit 26 identifies whether a distribution rule for the flow of which the distribution control unit 26 has been notified by the detecting unit 62 is registered in the distribution table 52, with reference to the transmission flow table 71. If no distribution rule for the flow of which the distribution control unit 26 has been notified by the detecting unit 62 is registered in the distribution table 52, the distribution control unit 26 notifies the distribution determining unit 23 of the information about the flow through which a large amount of transmission was detected. Processing performed in the distribution determining unit 23 is the same as in the first, third, or fourth embodiment.

The data output from the transmission processing unit 82 to the virtual communication processing unit 63, the data being intended to be transmitted, is output to the output processing unit 21 through the virtual switch 64. The output processing unit 21 receives the data and outputs it to the transmission processing unit 30.

Next, processing in which the communication apparatus 90 receives a packet will be described. Processing performed by the interface 16 for a received packet is the same as in the first to fourth embodiments. Therefore, a packet stored in one of the receive queues 42a to 42d is entered into the reception processing unit 24 that is associated with the queue in advance. The reception processing unit 24 outputs the entered packet through the virtual switch 64 to the virtual communication processing unit 61. If a plurality of virtual machines 85 are operating in the communication apparatus 90, the received packet is output through the virtual switch 64 to the virtual machine 85 that uses the destination address for the received packet. The virtual communication processing unit 61 receives the packet and outputs it to the reception processing unit 81. The reception processing unit 81 receives the packet, performs reception processing on it, and outputs the packet to the protocol processing unit 14.

As described above, in the fifth embodiment, it is possible to determine, in the communication apparatus 90 as well in which virtual machines 85 are used, a processor 101 intended to process a large amount of acknowledgment packets that are assumed to be received, as in the first to fourth embodiments.

Others

Embodiments are not limited to those described above; various modifications are possible. Some examples of modifications will be described below.

In the communication apparatus 90 as well, in which the virtual machine 85 is operating, it is also possible to assign processing on acknowledgment packets to the processor 101 that has created the relevant transmission data, as in the second embodiment.

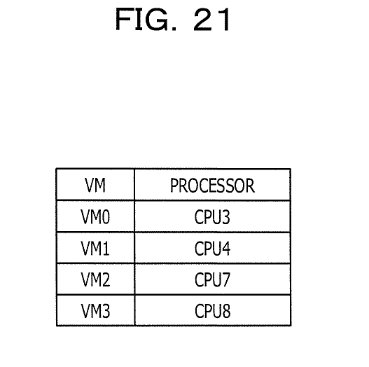

FIG. 21 illustrates an example of the processor table 73. In the communication apparatus 90, when processing on acknowledgment packets is assigned to the processor 101 that has performed data transmission processing, the distribution determining unit 23 uses the processor table 73, as in the second embodiment. In the processor table 73, processors 101 that are executing their corresponding virtual machines 85 are recorded in correspondence to identification information about the virtual machines 85. In the example in FIG. 21, for example, VM0 is being executed by CPU 3 and VM2 is being executed by CPU 7. The distribution determining unit 23 identifies the virtual machine 85 that is processing a flow of which the distribution determining unit 23 has been notified by the distribution control unit 26, with reference to the transmission flow table 71. Next, the distribution determining unit 23 identifies, from the processor table 73, the processor 101 executing the virtual machine 85 that is processing the flow. The distribution determining unit 23 assigns processing on acknowledgment packets to the processor 101 in which the virtual machine 85 that has created the relevant transmission data is operating. The distribution determining unit 23 references the queue table 53 and identifies the receive queue 42 associated with the processor 101 to which processing on acknowledgment packets has been assigned, after which the distribution determining unit 23 updates the distribution table 52 accordingly as in the second embodiment.

Furthermore, information elements included in the tables used in all embodiments can also be changed depending on the implementation. The tables, each of which has been described above as a single table, may be divided into a plurality of tables, depending on the implementation.

In all embodiments described above, if there is a flow through which a transmission has not been performed within a predetermined period (Tht2), the communication apparatus may delete, from the distribution table 52, an entry about a flow in a direction opposite to the direction of that flow. For example, the detecting unit 22 can notify the distribution determining unit 23 of any flow, included in the transmission flow table 51, through which there has been no transmission within the period Tht2. The distribution determining unit 23 deletes, from the distribution table 52, an entry about a flow in a direction opposite to the direction of the flow of which the distribution determining unit 23 has been notified by the detecting unit 22. The detecting unit 22 also deletes, from the transmission flow table 51, information about the flow for which the detecting unit 22 has notified the distribution determining unit 23 that there had been no transmission within the period Tht2. In this modification, even in a case in which there is a limitation on the number of entries that can be registered in the distribution table 52, the communication apparatus 10 can efficiently perform distribution processing. In the communication apparatus 90 as well, the detecting unit 62 can notify, through the distribution control unit 26, the distribution determining unit 23 of a flow, in the transmission flow table 71, through which there has been no transmission within the period Tht2. The detecting unit 62 can delete, from the transmission flow table 71, an entry about the flow through which there has been no transmission within the period Tht2. In the communication apparatus 90 as well, in which the virtual machine 85 is operating, the distribution table 52 can be efficiently operated.

In the case of communication in which TCP is used, if there has been no transmission within a certain period, communication is restarted in a slow start method. Therefore, since if there has been no communication within a predetermined period between apparatuses that use TCP in communication, transmission and reception of a large amount of data is not performed immediately, distribution processing is efficiently performed by processing described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet communication apparatus comprising:
a memory; and
a plurality of processors including a specified processor, a first processor of the plurality of processors being configured to process each acknowledgement packet in a first receive flow that corresponds to a first transmission flow including each data packet corresponding to each acknowledge packet in the first receive flow when the first receive flow has been associated with the first processor, the specified processor being configured to associate a receive flow with a processor when the receive flow has not been associated with the processor and when an amount of data in a transmission flow corresponding to the receive flow is more than a predetermined value, a second processor of the plurality of processors being configured to process each acknowledgement packet in a second receive flow that corresponds to a second transmission flow including each data packet corresponding to each acknowledge packet in the second receive flow when the second receive flow has not been associated with the second processor and when an amount of data in the second transmission flow corresponding to the second receive flow is not more than the predetermined value, the specified processor being configured to select the second processor based on each acknowledge packet in the second receive flow.

2. The packet communication apparatus according to claim 1, wherein
the specified processor is configured to recognize that the amount of the data is more than the predetermined value when the amount of data requested by one transmission request from an upper layer in the packet communication apparatus is more than the predetermined value.

3. The packet communication apparatus according to claim 1, wherein
the specified processor is configured to recognize that the amount of the data is more than the predetermined value when the amount of total data requested by transmission requests for a predetermined period from an upper layer in the packet communication apparatus is more than the predetermined value.

4. The packet communication apparatus according to claim 1, wherein
the specified processor is configured to:
detect a period between two transmission requests from an upper layer in the packet communication apparatus, and
calculate the amount of the data based on a function of a first amount and a second amount, the first amount being a decreasing amount of a data packet of which a corresponding acknowledgement packet is not received for the period, the second amount being an amount of the data requested by a latter transmission request of the two transmission requests.

5. The packet communication apparatus according to claim 1, wherein
the specified processor is configured to select the processor associated with the receive flow so that a processor having a relatively lower processing load is more preferentially selected.

6. The packet communication apparatus according to claim 1, wherein
the specified processor is configured to select the processor associated with the receive flow to be a processor that processes the transmission flow corresponding to the receive flow.

7. A packet communication method comprising:
processing, by a first processor of a plurality of processors, each acknowledgement packet in a first receive flow that corresponds to a first transmission flow including each data packet corresponding to each acknowledge packet in the first receive flow when the first receive flow has been associated with the first processor;
associating, by a specified processor of the plurality of processors, a receive flow with a processor when the receive flow has not been associated with the processor and when an amount of data in a transmission flow corresponding to the receive flow is more than a predetermined value;
processing, by a second processor of the plurality of processors, each acknowledgement packet in a second receive flow that corresponds to a second transmission flow including each data packet corresponding to each acknowledge packet in the second receive flow when the second receive flow has not been associated with the second processor and when an amount of data in the second transmission flow corresponding to the second receive flow is not more than the predetermined value; and
selecting, by the specified processor, the second processor based on each acknowledge packet in the second receive flow.

8. The packet communication method according to claim 7, wherein
the specified processor is configured to recognize that the amount of the data is more than the predetermined value when the amount of data requested by one transmission request from an upper layer in the packet communication apparatus is more than the predetermined value.

9. The packet communication method according to claim 7, wherein
the specified processor is configured to recognize that the amount of the data is more than the predetermined value when the amount of total data requested by transmission requests for a predetermined period from an upper layer in the packet communication apparatus is more than the predetermined value.

10. The packet communication method according to claim 7, wherein
the specified processor is configured to:
detect a period between two transmission requests from an upper layer in the packet communication apparatus, and
calculate the amount of the data based on a function of a first amount and a second amount, the first amount being a decreasing amount of a data packet of which a corresponding acknowledgement packet is not received for the period, the second amount being an amount of the data requested by a latter transmission request of the two transmission requests.

11. The packet communication method according to claim 7, wherein
the specified processor is configured to select the processor associated with the receive flow so that a processor having a relatively lower processing load is more preferentially selected.

12. The packet communication method according to claim 7, wherein
the specified processor is configured to select the processor associated with the receive flow to be a processor that processes the transmission flow corresponding to the receive flow.
